(19) United States
(12) Patent Application Publication
(10) Pub. No.: US 2013/0054591 A1
(43) Pub. Date: Feb. 28, 2013

(54) SEARCH ENGINE OPTIMIZATION RECOMMENDATIONS BASED ON SOCIAL SIGNALS

(71) Applicants: LEMUEL S. PARK, CERRITOS, CA (US); LENNON LIAO, SAN MATEO, CA (US); SAMMY YU, SAN MATEO, CA (US); JIMMY YU, FOSTER CITY, CA (US)

(72) Inventors: LEMUEL S. PARK, CERRITOS, CA (US); LENNON LIAO, SAN MATEO, CA (US); SAMMY YU, SAN MATEO, CA (US); JIMMY YU, FOSTER CITY, CA (US)

(73) Assignee: BRIGHTEDGE TECHNOLOGIES, INC., SAN MATEO, CA (US)

(21) Appl. No.: 13/270,917

(22) Filed: Oct. 11, 2011

Related U.S. Application Data
(60) Provisional application No. 61/449,064, filed on Mar. 3, 2011.

(51) Int. Cl. G06F 17/30

(52) U.S. Cl. 707/736; 707/E17.005

(57) ABSTRACT

One example includes a method of increasing search engine optimization (SEO) performance of a social media website of an entity. The method includes obtaining SEO data from a webpage of the entity and obtaining SEO data from the social media webpage of the entity. The method further includes generating a report based on the SEO data from the webpage and SEO data from the social media webpage that indicates a level of the search engine optimization performance of the social media webpage of the entity.

### BACKGROUND

Search engine optimization (SEO) generally describes the use of computing systems for running computing processes that collect, store, and analyze search engine data in order to provide recommendations to improve visibility of a website or a webpage in search engines. Search engine results can be obtained by one or more search strategies, such as natural, un-paid, organic, or algorithmic search results as well as for paid search algorithms of search engine marketing (SEM) target paid listings. Generally, the higher a website is located on a website listing and the more frequently a website appears in the search results list, the more visitors it will receive from the search engine's users. The SEO can improve the availability of a website or a webpage to internet users.

SEO is implemented by Internet Technology (IT) professionals to improve the volume and quality of traffic to a given webpage or other Internet site. Companies and individuals may employ SEO to improve the volume and quality of traffic to their websites to increase sales, brand recognition, dissemination of their product, advertising, or for any other purpose.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In general, example embodiments relate to a method of increasing search engine optimization performance of a social media webpage of an entity. The method can include obtaining SEO data from an entity's webpage and obtaining SEO data from the same entity's social media webpage. The method can further include generating a report based on the SEO data from the webpage and the social media webpage that indicates a level of the search engine optimization performance of the social media webpage of the entity.

In some embodiments, the method can include identifying one or more external references to the entity's social media webpage located on the entity's website. The method can further include analyzing social media correspondences located on the entity's social media webpage for references to the entity and identifying the number of social media acknowledgements for the entity's social media webpage.

In some embodiments, the report contains one or more recommendations for increasing the search engine optimization performance of the social media webpage of the entity.

In some embodiments, obtaining SEO data from the webpage of the entity includes crawling the webpage of the entity for links to the social media webpage. In some embodiments, obtaining SEO data from the social media webpage of the entity includes analyzing social media correspondences located on the social media webpage for references to the entity.

In some embodiment, obtaining SEO data from the social media webpage of the entity includes identifying the number of social media acknowledgements for the social media webpage of the entity.

These and other aspects of example embodiments of the invention will become more fully apparent from the following description and appended claims.

### BRIEF DESCRIPTION OF THE DRAWINGS

To further clarify various aspects of some embodiments of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates an embodiment of a SEO system;

FIG. 1B illustrates another embodiment of a SEO system;

FIG. 2 illustrates a method of increasing SEO performance of webpages of a website;

FIG. 3 illustrates a representation of a screenshot of a graphical interface;

FIG. 4 illustrates a representation of a screenshot of a graphical interface;

FIG. 5 illustrates a representation of a screenshot of a graphical interface;

FIG. 6 illustrates an embodiment of a computing system that can implement some embodiments described herein;

are arranged in accordance with at least one of the embodiments described herein, and which arrangement may be modified in accordance with the disclosure provided herein by one of ordinary skill in the art.

### DETAILED DESCRIPTION OF EXAMPLE EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With the rise in the wide spread use of social media and its integration into the daily lives of internet users, companies and individuals (e.g., “entities”) are realizing the benefits that may be achieved by using social media in their marketing strategies. As entities turn to social media, it may be desirable to improve the volume and quality of traffic to the entities' social media websites and webpages and create synergies between the entities' social media webpages and their other websites. Alternately or additionally, it may be desirable to track any synergies created between their social media webpages and their other websites.

Accordingly, embodiments disclosed herein generally relate to computing systems and computing processes used in methods of improving SEO performance for social media webpages of an entity. The SEO performance can be optimized with respect to the different social media webpages of the entity to increase the internet traffic of the social media webpage. By increasing the internet traffic of a social media webpage, an entity can achieve greater brand visibility. Furthermore, increasing the internet traffic of a social media webpage can lead to increased traffic of an entity's main webpage and better page rank for the entity's webpage.

Some embodiments can include a computing system that has an analytic module configured to analyze and collect SEO data and metrics from a social media webpage, a determination module configured to determine a level of SEO for the social media webpage, and a reporting module configured to make a recommendation to change the parameters of the particular social media webpage to increase the internet traffic to the webpage. The analytic module can be configured as software to include an analytic engine that can process analytic algorithms in accordance with the teachings provided herein. The determination module can be configured as software to include a determination engine that can process determination algorithms in accordance with the teachings provided herein. The reporting module can also be configured as software to include a reporting engine that can process reporting algorithms in accordance with the teachings herein.

An example embodiment is described as follows, a company can have a general company website and a social media webpage, such as a Facebook page, with information about the company. Some embodiments are configured to improve SEO of the social media webpage by crawling the website of the company and its social media webpage to collect webpage specific SEO data, analyzing the collected SEO data, and providing a recommendation on one or more strategies to improve web traffic patterns on the company's social media webpage. Previously, SEO has not been implemented in order to optimize search results for social media webpages of companies. Now, embodiments described herein can provide recommendations for increasing the SEO performance of social media webpages, such as with the Facebook page recited above, in order to improve internet traffic to the social media webpage, brand recognition, and search rank of the entity's main website.

Some factors that can affect the SEO performance of a social media webpage can include, external references, such as links, to the social media webpage from a company's main webpage. Increasing the number of links to the social media webpage can give validity to the social media website. Additionally or alternatively, another factor can include the number of social correspondences, such as wall posts of Facebook, that include references to the company. Increasing the number of references to the company, especially when the references are branded names of the company, increases the social media webpage's visibility to search engines.

Additionally or alternatively, another factor can include the number of social media acknowledgements, such as a Facebook like, that the social media webpage receives from users of the social media. Increasing the number of social media acknowledgements can increase the number of external references to the social media webpage and thereby improve the search engine rankings of the social media webpage. By correlating the entity's website to the entity's social media webpage and increasing the search engine ranking of the social media webpage, the search engine ranking of the entity's website can improve. Furthermore, a synergistic effect can occur between the entity's website and the entity's social media webpage because of the linking between the sites that can improve the search engine rankings of both the entity's website and social media webpage.

Reference will now be made to the figures wherein like structures will be provided with like reference designations. It is understood that the figures are diagrammatic and schematic representations of some embodiments of the invention, and are not limiting of the present invention, nor are they necessarily drawn to scale.

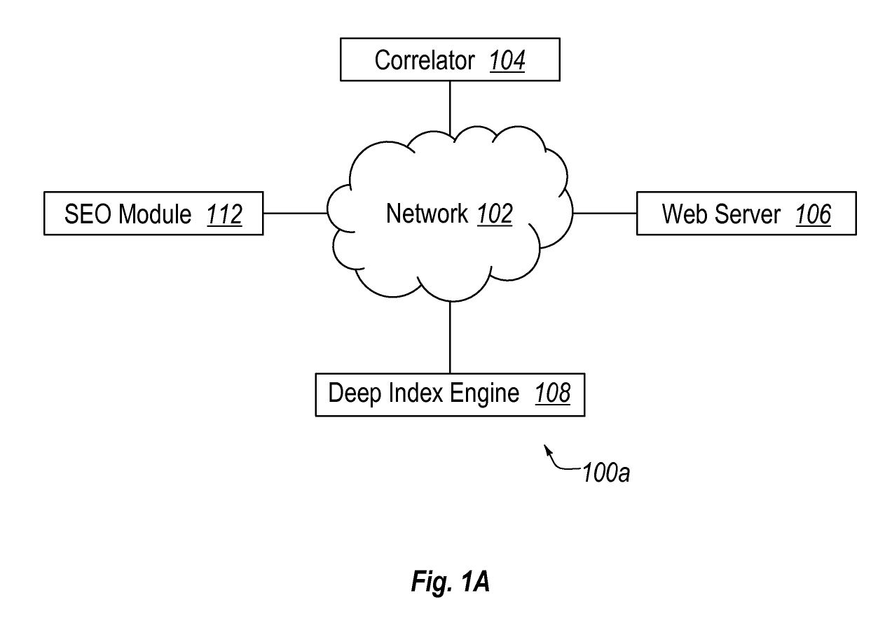

FIG. 1A illustrates an embodiment of a SEO system 100a, which can include a network 102. In some embodiments, the network 102 can be used to connect the various parts of the system 100a to one another, such as between a web server 106, a deep index engine 108, a correlator 104, and a SEO module 112. It will be appreciated that while these components are shown as separate, the components may be combined as desired. Further, while one of each component is illustrated, the system 100a may optionally include any number of each of the illustrated components.

The network 102 may include the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 102 includes one or more cellular RF networks and/or one or more wired and/or wireless networks such as, but not limited to, 802.xx networks, Bluetooth access points, wireless access points, IP-based networks, or the like. The network 102 can also include servers that enable one type of network to interface with another type of network.

The web server 106 can include any system capable of storing and transmitting a webpage to a user. The web server 106 can provide access to the webpages of a website to be analyzed for improving SEO. For example, the web server 106 can include a computer program that is responsible for accepting requests from clients (user agents such as web browsers), and serving them HTTP responses along with optional data contents, which can include HTML documents and linked objects for display to the user. Additionally or alternately, the web server 106 can include the capability of logging some detailed information, about client requests and server response, to log files.

The website can include any number of webpages. The aggregation of references to the various webpages can be referred to as traffic. It should be noted that the term webpage, as used herein, refers to any online posting, including domains, subdomains, web posts, Uniform Resource Identifiers (“URIs”), Uniform Resource Locators (“URLs”), images, videos, or other piece of content and non-permanent postings such as e-mail and chat, unless otherwise specified.

External references to a webpage can include any reference to the webpage which directs a visitor to the webpage. For example, an external reference can include text documents, such as blogs, news items, customer reviews, emails or any other text document that discusses the webpage. Alternately or additionally, an external reference can include a webpage that includes a link to the webpage. For example, an external reference can include other webpages, search engine results pages, advertisements or the like.

In some embodiments, the deep index engine 108 may be configured to crawl the webpages accessed by the webserver 106 to retrieve external data. In particular, the deep index engine 108 may be configured to crawl the webpages and analyze data associated with the crawl, including on-page information and back link data (e.g., back link URL, anchor text, etc.) for each webpage. A deep index engine 108 according to some embodiments is described in more detail in copending U.S. patent application Ser. No. 12/436,704 entitled COLLECTING AND SCORING ONLINE REFERENCES, filed May 6, 2009, which application is hereby incorporated by reference in its entirety. The functionalities described herein can be applied to optimizing webpages for a website.

A correlator 104 according to some embodiments is described in more detail in co-pending U.S. patent application Ser. No. 12/574,069, filed Oct. 6, 2009 entitled CORRELATING WEB PAGE VISITS AND CONVERSIONS WITH EXTERNAL REFERENCES, which application is hereby incorporated by reference in its entirety. The functionalities described herein can be applied to optimizing webpages for a website.

The correlator 104 or other component may be configured to collect web analytics data from the webpages. The web analytics data may be used in estimating the cost, value, or both, associated with one or more SEO opportunities. Examples of web analytics data that may be collected include number of visitors, page views, conversions (e.g., purchases), and the like or any combination thereof.

The SEO module 112 is configured for orchestrating and performing the webpage analysis of a website as described herein so that recommendations can be made to improve the website and its webpages. The SEO module 112 is described in more detail herein.

FIG. 1B illustrates another embodiment of a SEO system 100b. As shown, the network 102 operably couples the SEO module 112 with a website computing system 128. The SEO module 112 includes an SEO computing system 120 configured to perform SEO analysis and produce recommendations as described herein. The SEO computing system 120 can include submodules for implementing particular functionalities. The SEO computing system 120 can be generic to and include an analytic module 122, determination module 124, and a reporting module 126.

The website computing system 128 can include a website database 129 that includes SEO data from entity webpages 132 from an entity website 130. The entity website 130 can be the website of an entity for which SEO is to be performed. The website database 129 can further include social media webpages 142 from a social media website 140 of the entity. The social media website 140 can be any type of social media. For example, social media can include collaborative projects (e.g. Wikipedia), blogs and microblogs (e.g. Twitter), content communities (e.g. Youtube), social networking sites (e.g. Facebook), virtual game worlds (e.g. World of Warcraft), and virtual social worlds (e.g. Second Life), among other types of social media and can take many different forms including Internet forums, weblogs, microblogging, social blogs, wikis, podcasts, photographs or pictures, video, rating, social bookmarking, and others. Additionally or alternatively, the website computing system 128 can contain a second website database so that the entity webpages 132 and the social media webpages 142 reside in separate databases. It should be understood that the data from the entity webpages 132 and the social media webpages 142 may be stored in any configuration without departing from the embodiments described herein.

The website computing system 128 can obtain the SEO data from the entity webpages 132 and the social media webpages 142 by accessing the entity website 130 and the social media website 140 through a web server, such as the web server 106 of FIG. 1A. Furthermore, the data from the entity webpages 132 and the social media webpages 142 can be collected by crawling the webpages 132, 142. In some embodiments, the webpages 132, 142 can be crawled using the deep index engine 108 of FIG. 1A, for instance. In some embodiments, the webpages 132, 142 can be crawled using a different mechanism.

Referring again to the SEO computing module 120, the analytic module 122 within the SEO computing module 120 can be configured to analyze the webpages 132, 142 to obtain one or more metrics, SEO data, or both from the webpage 132, 142. The analytic module 122 can include one or more algorithms for analyzing the data from the webpages 132, 142. For example, in some embodiments, the analytic module 122 can analyze on-page data and external references on the entity webpages 132 to identify external references to the social media webpages 142 of the entity. Additionally or alternatively, the analytic module 122 can analyze the on-page data to determine the location, on the entity webpages 132, of external references to the social media webpages 142. Additionally or alternatively, the analytic module 122 can analyze the on-page data of the social media webpages 142 to identify social media correspondences located on the social media webpages 142.

Social media correspondences can be any data placed on the social media webpages 142 by a user of the social media website 140 that can be read by other users of the social media website 140. For example, in some embodiments, social media correspondences can include posts, comments, or both on a social networking website. In other embodiments, social correspondence can include posts, comments, or both on a blog or microblog. It should be understood that the aforementioned are only some examples of different types of social correspondence and the scope of social media correspondences should not be limited in anyway by these examples.

Additionally or alternatively, after the analytic module 122 identifies the social media correspondences located on the social media webpages 142, the analytic module 122 can further analyze the social correspondence for one or more words, phrases, and other data using one or more algorithms. For example, in some embodiments, the analytic module 122 can analyze the social correspondence for keywords, such as references to the entity, which may include any branded names of the entity or other words that are associated with the entity, product names produced by the entity, relevant search terms, and other words used in SEO.

Additionally or alternatively, the analytic module 122 can analyze the on-page data and external references of the social media webpages 142, the social media website 140, or both to identify the number of social media acknowledgements for the social media webpages 142 of the entity. The social media acknowledgement can be anything that indicates that a user of the social media website 140, likes, acknowledges, agrees with, enjoys, recognizes, or prefers the social media webpages 142 of the entity. For example, in some embodiments, a social media acknowledgement can include a user of a social networking site, such as Facebook, indicating that they “like” the social media webpages 142 of the entity.

Additionally or alternatively, social media acknowledgements can include a user placing an external reference to the social media webpages 142 of the entity on another webpage. Additionally or alternatively, social media acknowledgements can include a user of a social media website following a blog or microblog, commenting on a post, or indicating in any other manner that they acknowledge the social media webpages 142 of the entity. It should be understood that the aforementioned are only some examples of different types of social media acknowledgements and the scope of social media acknowledgements should not be limited in anyway by these examples.

The determination module 124 can obtain data from the analytic module 122, and can determine a level of search engine optimization for the social media webpages 142 of the entity. The determination module 124 can include one or more algorithms for processing the data obtained from the analytic module 122. Based on the data from the analytic module 122, the determination module 124 can determine if and how many external references to the social media webpages 142 the entity webpages 132 contain. Additionally or alternatively, the determination module 124 can determine if the locations of the external references are in the same position on the separate entity webpages 132. For example, in some embodiments, the determination module 124 could determine that the external references to the social media webpages 142 on some entity webpages 132 were located on the footer of the webpage, while other of the entity webpages 132 had the external references on the header of the webpage.

Additionally or alternatively, the determination module 124 can determine the total number of social media correspondences on the social media webpages 142 based on the data from the analytic module 122. Additionally or alternatively, the determination module 122 can determine the number of social media correspondences on the social media webpages 142 that reference the entity and compare that number with the total number of social media correspondences on the social media webpages 142. For example, in some embodiments, the determination module 124 can determine the percentage of social media correspondences on the social media webpages 142 that contain a reference to the entity.

Additionally or alternatively, the determination module 124 can track the total number of social media correspondences on the social media webpages 142 and the number of social media webpages 142 that reference the entity over a period. Additionally or alternatively, the determination module 124 can track the number of social media acknowledgements for the social media webpages 142 for a period and compare the number of social media acknowledgements for the social media webpages 142 to a search results ranking for the entity website 130 over the period. For example, in some embodiments, the deep index engine 108, correlator 104, and web server 106 can determine the ranking for the entity website 130 over the period and send the results to the determination module 118 for comparison with the social media acknowledgements for the social media webpages 142. In some embodiments, another system can determine the ranking for the entity website 130 over the period and send the results to the determination module 118 for comparison with the social media acknowledgements for the social media webpages 142.

Additionally or alternatively, the determination module 118 can use the data collected from the social media webpages 142, the entity webpages 132, or both in one or more algorithms to determine a level of the SEO of the social media webpages 142. For example, in some embodiments, the determination module 118 can input the number of social acknowledgements, the percentage of social media correspondences that contain references to the entity, the number or existence of external references to the social media webpages 142 located on the entity website 130, other SEO data collected by the analytic module 122, or any combination thereof into one or more algorithms to determine a level of SEO of the social media webpages 142.

The reporting module 126 can compile information from the analytic module 122, determination module 124, or both to generate a report and make recommendations to improve SEO performance of the social media webpages. The reporting module 126 can include one or more algorithms that can generate one or more reports and provide one or more recommendations for improved SEO performance.

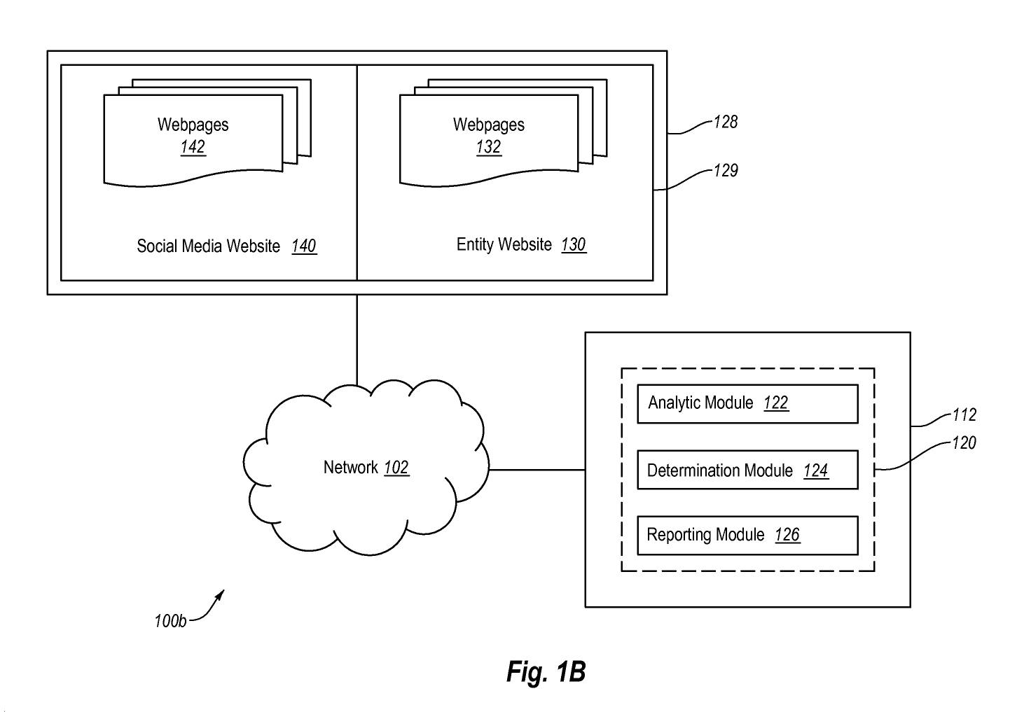

FIG. 2 illustrates a general method 200 for increasing SEO performance of a social media webpage of an entity. The method 200 may be implemented in the SEO system 100a or 100b of FIG. 1A or 1B, for instance. The method 200 is shown to include obtaining and analyzing SEO data from a webpage of an entity at block 210. In some embodiments, obtaining and analyzing SEO data from the webpage of the entity can include crawling the website of the entity, obtaining SEO data from the website, and identifying external references to the social media webpage of the entity located on one or more webpages of the entity's website. If more than one webpage of the entity includes an external reference, the webpages that include the external references can be analyzed to determine the location of the external references on the webpages. Webpages that locate the external references in different locations can be noted. Additionally or alternatively, a list can be complied that lists all of the different locations for the external references on the webpages of the entity's website. Analysis can also be performed using data from a correlator (e.g. the correlator 104 of FIG. 1A) to provide information regarding which external references are used more often by users of the entity's website to link to the social media webpage of the entity. Using this information, analysis can be performed to determine the ideal location for the external references, the ideal nomenclature to use for the external references, and other pertinent information relating to the external references.

Additionally or alternatively, the titles of the external references can be analyzed to determine if the title is a brand name of the entity or some other name that it is associated with the entity. In any event, the titles of the external references can be noted and compiled for reporting or other use.

The method 200 can further include obtaining and analyzing SEO data from the social media webpage of the entity at block 220. In some embodiments, obtaining and analyzing SEO data from the social media webpage of the entity can include crawling the social media webpage, obtaining SEO data from the webpage, and analyzing social correspondence located on the social media webpage for references to the entity.

Additionally or alternatively, the method 200 can further include determining the total number of social media correspondences located on the social media webpage and comparing the total number of social media correspondences to the number of social media correspondences on the social media webpage that reference the entity. Using the information determined above, the percent of social media correspondences that include a reference to the entity can be calculated. Additionally or alternatively, the method can include tracking the total number of social media correspondences located on the social media website for a period and tracking the number of those social media correspondences that reference the entity for the same period.

In some embodiments, obtaining and analyzing SEO data from the social media webpage of the entity can include crawling the social media webpage, obtaining SEO data from the social media webpage, and identifying the number of social media acknowledgements for the social media webpage. Additionally or alternatively, the method 200 can include tracking the number of social media acknowledgements for the social media webpage for a period. Additionally or alternatively, the method 200 can include comparing the number of social media acknowledgements for the social media webpage for the period to search result rankings for the website of the entity for the same period.

In some embodiments, obtaining and analyzing SEO data from the social media webpage of the entity can include both identifying the number of social media acknowledgements for the social media webpage of the entity and analyzing social correspondence located on the social media webpage for references to the entity.

The method 200 can further include generating a report based on the SEO data that indicates a level of SEO of the social media webpage at block 230. In some embodiments, the level of SEO of the social media webpage can be determined using one or more factors. The factors can include the number of social acknowledgements, the percentage of social media correspondences that contain references to the entity, the number or existence of external references to the social media webpage of the entity located on the entity website, other SEO data, or other factors.

Additionally or alternatively, the report can contain one or more recommendations for increasing the search engine optimization performance of the social media webpage of the entity. The recommendations can include any factors that directly or indirectly relate to the level of SEO of the social media webpage. The recommendation can also be based on the analyses of the SEO data from the website of the entity and the social media webpage of the entity. For example, if the analysis of the website of the entity showed that the webpages contained no external references, the recommendation can be to include external references to the social media webpage on the entities website. In some embodiments, the recommendation can further include to title the external reference with the entities brand name, some other word or words associated with the entity, an external reference name used most often by users of the entity's website, or any combination thereof. In some embodiments, the recommendation can further include to place the external references in the same locations on the webpages of the entity's website or at an ideal location based on past patterns of the entity's website users.

As another example, if the analysis of the website of the entity showed that the social media correspondence did not reference the entity, the recommendation can be to ensure that any social media correspondences produced by the entity on the social media webpage includes the brand name of the entity, some other word or words associated with the entity, SEO key terms, or any combination thereof. As another example, to increase the number of social recommendation, the recommendation can be to include the ability for visitors of the entity's website to make a social recommendation for the social media webpage of the entity.

Furthermore, the method 200 can be performed for more than one social media webpage of the entity. The method 200 can be performed concurrently for all of an entity's social media webpages or for some of the entity's social media webpages and not others. If the method is performed concurrently for more than one social media webpage, the entity's website can be crawled and SEO data obtained and analyzed for external references to each of the different social media webpages. The social media webpages can be crawled and SEO data obtained and analyzed in parallel or in a serial configuration.

Additionally or alternatively, the social media webpages may be grouped together according to types and the method performed on the groups to allow general reporting and recommendations to be made for each group of social media webpages. In some embodiments, the grouping can be determined according to social media types that are similar. For example, social networking webpages could be grouped together.

It should be understood that the method 200 need not be performed in the order presented. For example, block 220 may be accomplished before block 210. Furthermore, other method steps as described herein may be included in the method 200. Additionally, not all of the steps in the method 200 need be performed. For example, the method 200 may omit block 210.

An example of increasing SEO performance of a social media webpage of an entity is provided as follows. An entity, such as a company, can have a company website and a social media webpage, such as a Facebook page. One or more webpages of the company's website can be crawled, SEO data obtained and analyzed to determine if the one or more webpages contain an external reference, such as a link, to the company's Facebook page. The company's Facebook page can also be crawled and SEO data obtained and analyzed to determine the total number of social media correspondences on the Facebook page, such as posts, that contain the brand name of the company. The Facebook page can also be crawled, SEO data obtained and analyzed to determine the number of social media acknowledgements, such as Facebook Likes, that the Facebook page has accumulated. A report can be generated to reflect the data obtained and analyzed. The report can contain recommendations regarding actions that the company can take to increase the SEO performance of their Facebook page. The report can also contain charts and comparisons to illustrate the data that was obtained and analyzed.

Another example of increasing SEO performance of a social media webpage of an entity is provided as follows. An entity, such as a company, that has a company website can also have a social media webpage, such as a Twitter account. One or more webpages of the company's website can be crawled, SEO data obtained and analyzed to determine if the one or more webpages contain an external reference, such as a link, to the company's Twitter account. The Twitter account can also be crawled, SEO data obtained and analyzed to determine the total number of social media correspondences on the Twitter account, such as the number of tweets that contain the brand name of the company. The Twitter account can also be crawled and SEO data obtained and analyzed to determine the number of social media acknowledgements, such as the number of followers or the number of listed followers that the company's Twitter account has accumulated. A report can be generated to reflect the data obtained and analyzed. The report can contain recommendations regarding actions that the company can take to increase the SEO performance of their Twitter account. The report can also contain charts and comparisons to illustrate the data that was obtained and analyzed.

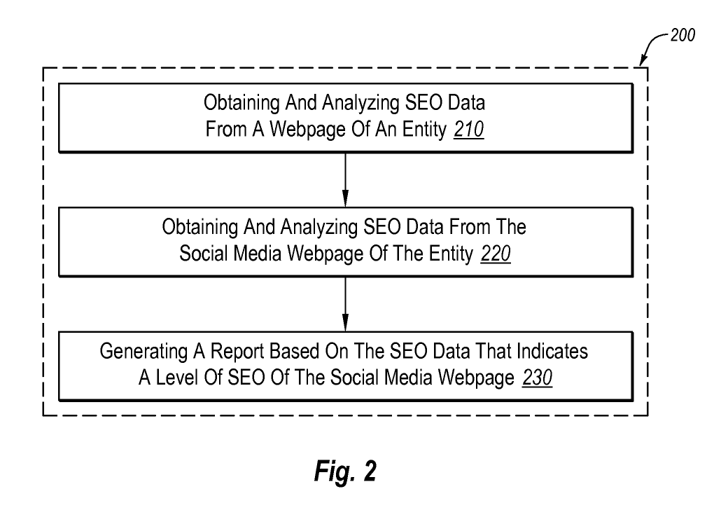

FIG. 3 illustrates an example of a screen shot of a graph that tracks the number of social acknowledgements (e.g. Facebook Likes) for the social media webpage (e.g. Facebook page) of an entity over a period.

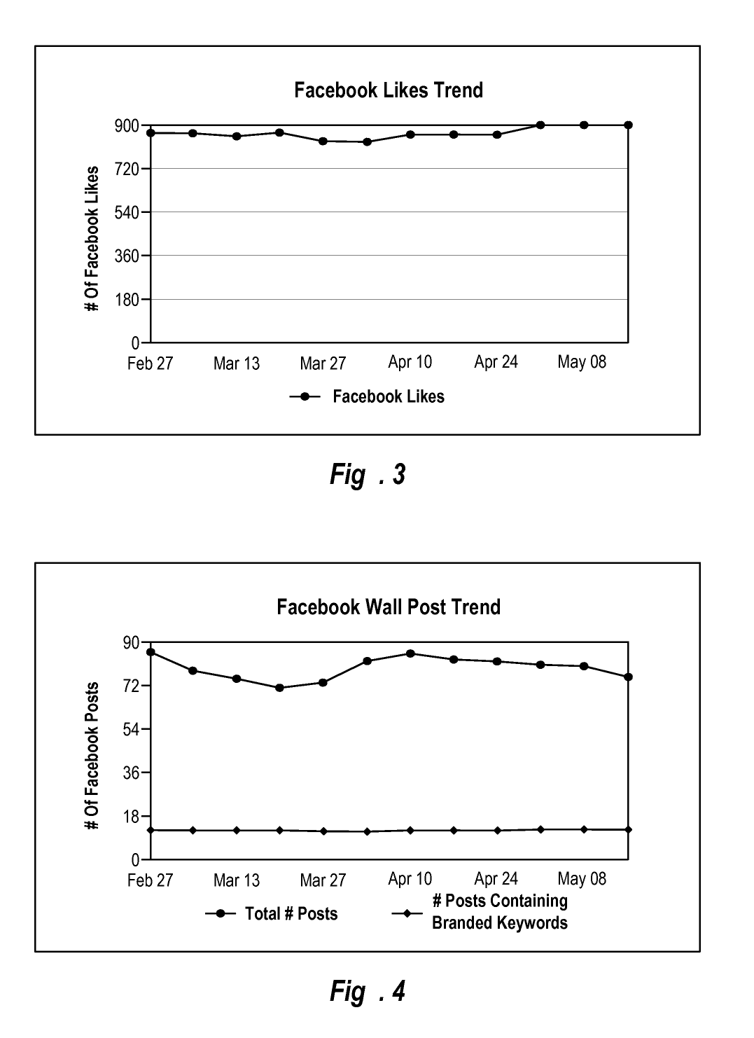

FIG. 4 illustrates an example of a screen shot of a graph that tracks the total number of social media correspondences (e.g. Facebook Wall Posts) located on a social media webpage (e.g. Facebook page) of an entity. The graph also tracks the number of social media correspondences (e.g. Facebook Wall Posts) located on the social media webpage (e.g. Facebook page) that contains references to the entity (e.g. branded Keywords). The graph compares the total number of social media correspondences with the number of social media correspondences that contain references to the entity for a specific date, for a period, or both.

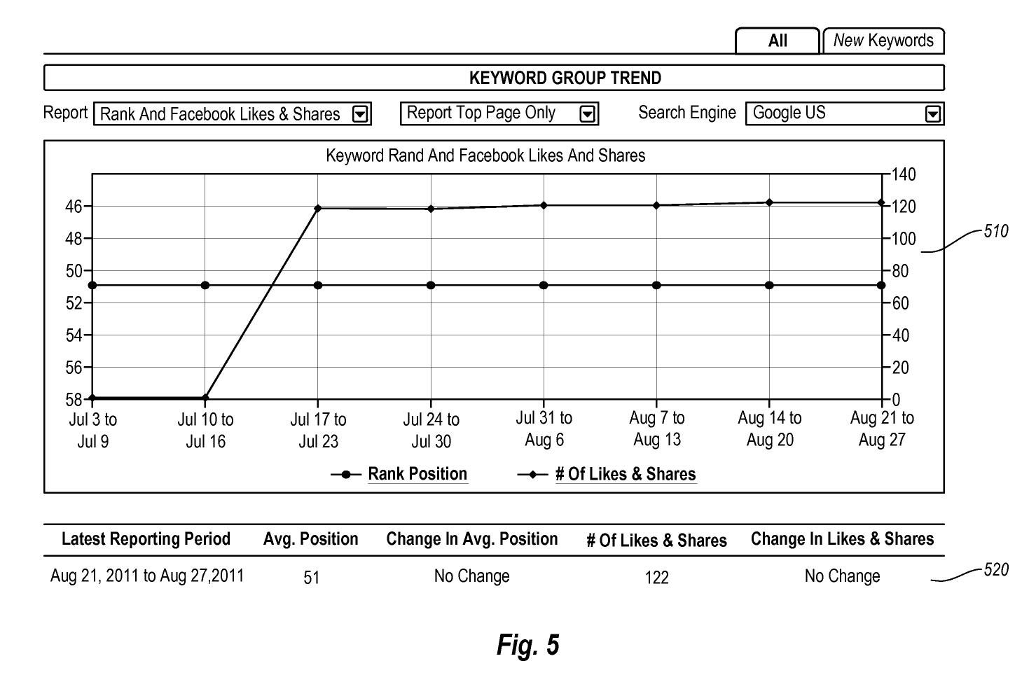

FIG. 5 illustrates an example of a screen shot of a graph 510 that tracks the number of social acknowledgements (e.g. Facebook Likes) for a social media webpage (e.g. Facebook page) of an entity over a period. The graph 510 can also track search result rankings for the website of the entity over the same period. The graph 510 can also compare the number of social acknowledgements and the entity's website rankings for a specific date, for a period, or both.

FIG. 5 further illustrates a table 520 that shows the average search result ranking for the entity's website for a specific period, such as a week and the change in the average rank position of the entity's website. The table 520 can also show a number of social acknowledgements (e.g. Facebook Likes) for the entity's social media webpage for the same period and the change in the number of social acknowledgements.

Additional information, besides the information described above with regard to FIGS. 3-5, can be reported by a reporting module (e.g. the reporting module 126 of FIG. 1B). For example, a reporting module can report on the number of external references to the social media webpage found on the entity's website. Additionally, or alternatively, the reporting module can report on the names used for the external references and the frequency of the names used. Additionally or alternatively, the reporting module can report where the external references are located on the webpages of the entity's website. Additionally or alternatively, the module can report information determined by a correlator (e.g. the correlator 104 of FIG. 1A) that shows which of the external references on the entity's website is used the most to link to the social media webpage of the entity.

Furthermore, FIGS. 3-5 illustrate graphs and tables that provide information on the SEO performance for a single social media webpage. If an entity has more than one social media webpage, a reporting module (e.g. the reporting module 126 of FIG. 1B) can provided rolled-up reporting on the multiple social media webpages or the reporting module can provide individual reports for each social media webpage. The rolled-up reporting for multiple social media webpages can provide information regarding which webpage has external references on the entity's website, the total number of social media correspondences and the number of social media correspondences containing references to the entity, the number of social media acknowledgements, and other information. Additionally or alternatively, the rolled-up report can show which of the social media webpages has the most social media acknowledgements, the highest percent of social media correspondence that contain references to the entity, other information, or any combination thereof. New social media webpages can be added at any time to the rolled-up report. However, the rolled-up reporting may not be retroactive. In these and other embodiments, the social media webpages can take effect in the system after they are added.

Additionally or alternatively, the rolled-up reporting can provide the ability to define which of the social media webpages are included in the rolled-up report. For example, the social media webpages that are social networking webpages can be included in the report. Additionally or alternatively, multiple rolled-up reports can be provided. Each report can contain reports for one or more categories or groups of social media webpages. For example, all the social media blogging webpages can be grouped together and all the social networking webpages can be grouped together for reporting purposes and a rolled-up report can be provided for both groups.

Some embodiments disclosed herein include a computer program product having computer-executable instructions for causing a computing system having the computer program product to perform a computing method of the computer-executable instructions for improving SEO of social media webpages of an entity. The computing method can be any method described herein as performed by a computing system. The computer program product can be located on a computer memory device, which may be removable or integrated with the computing system.

Some embodiments include a computing system capable of performing the methods described herein. As such, the computing system can include a memory device that has the computer-executable instructions for performing the method.

In some embodiments, a computing device, such as a computer or memory device of a computer, can include an analytic module, determination module, and reporting module. The analytic module, determination module, and reporting module can be configured to perform any of the methods described herein. Also, the analytic module, determination module, and reporting module can be combined into a single module or on a single platform.

The computer program product can include one or more algorithms for performing any of the methods of any of the claims. The computer program product can include one or more algorithms for performing any of the methods of any of the claims.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. It should also be recognized that any module or component described herein can implement the functionalities associated with the name of the module or component.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In some embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

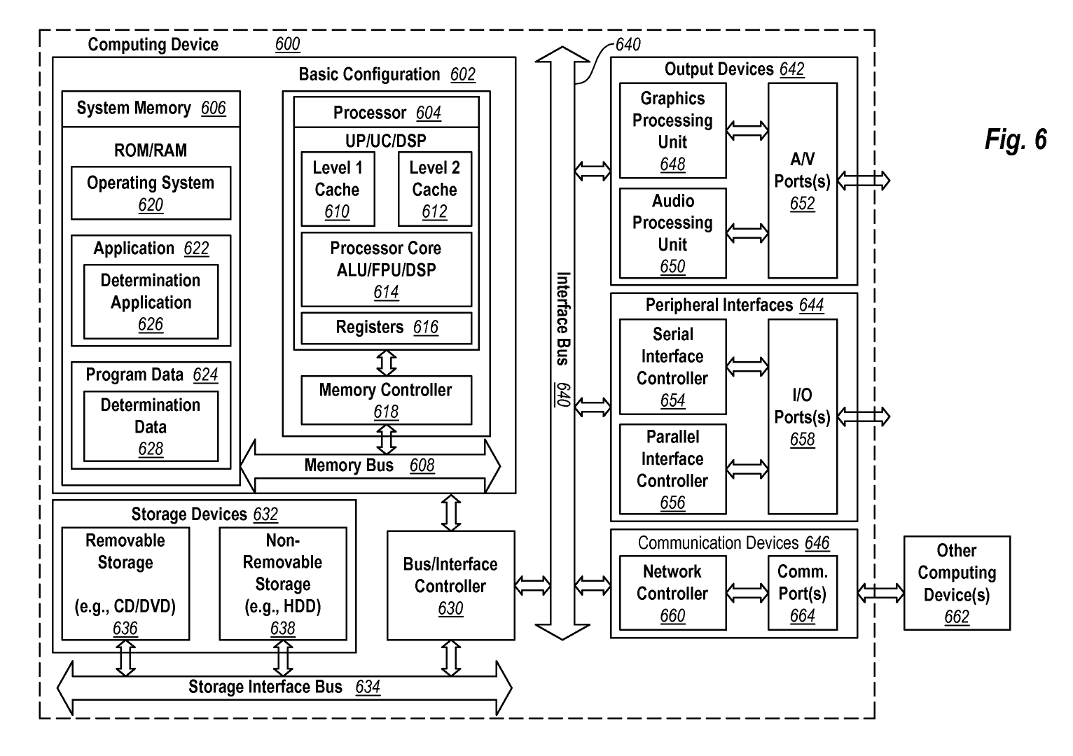

FIG. 6 shows an example computing device 600 that is arranged to perform any of the computing methods described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include a determination application 626 that is arranged to perform the functions as described herein including those described with respect to methods described herein. The determination application 626 may correspond to the determination module 124 of FIG. 1B, for example. Program Data 624 may include determination information 628 that may be useful for analyzing social media correspondences located on the social media webpage. In some embodiments, application 622 may be arranged to operate with program data 624 on operating system 620.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more NV ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data that cause a general-purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims. All references recited herein are incorporated herein by specific reference in their entirety.

1. A method of increasing search engine optimization performance of a social media webpage of an entity, the method comprising:
identifying one or more external references to the social media webpage of the entity located on the website of the entity;
analyzing social media correspondences located on the social media webpage of the entity for references to the entity; and
identifying the number of social media acknowledgements for the social media webpage of the entity.

2. A method according to claim 1, further comprising determining the total number of social media correspondences located on the social media webpage and comparing the total number of social media correspondences to the number of social media correspondences on the social media webpage that reference the entity.

3. A method according to claim 1, further comprising tracking the total number of social media correspondences located on the social media webpage for a period and comparing the total number of social media correspondences for the period to the number of social media correspondences on the social media webpage that reference the entity for the same period.

4. A method according to claim 1, wherein the social media acknowledgements indicate that another webpage has a link to the social media webpage of the entity.

5. A method according to claim 1, wherein the social media acknowledgements are produced by users of a social media of the social media webpage.

6. A method according to claim 1, further comprising tracking the number of social media acknowledgements for the social media webpage of the entity for a period.

7. A method according to claim 6, further comprising comparing the number of social media acknowledgements for the social media webpage of the entity for the period to organic search results for the webpage of the entity for the same period.

8. A method according to claim 1, further comprising generating a report indicating a level of the search engine optimization performance of the social media webpage of the entity.

9. A method according to claim 8, wherein the report contains one or more recommendations for increasing the search engine optimization performance of the social media webpage of the entity.

10. A method according to claim 1, wherein the references to the entity are brand names for the entity.

11. A method according to claim 1, wherein the social media webpage is a social networking webpage.

12. A method of increasing search engine optimization performance of a social media webpage of an entity, the method comprising:
obtaining SEO data from a webpage of the entity;
obtaining SEO data from the social media webpage of the entity; and
generating a report based on the SEO data from the webpage and SEO data from the social media webpage that indicates a level of the search engine optimization performance of the social media webpage of the entity.

13. A method according to claim 12, wherein the report contains one or more recommendations for increasing the search engine optimization performance of the social media webpage of the entity.

14. A method according to claim 12, wherein obtaining SEO data from the webpage of the entity comprises crawling the webpage of the entity for external references to the social media webpage.

15. A method according to claim 12, wherein obtaining SEO data from the social media webpage of the entity comprises analyzing social media correspondences located on the social media webpage for references to the entity.

16. A method according to claim 15, further comprising tracking the total number of social media correspondences located on the social media webpage for a period and comparing the total number of social media correspondences for the period to the number of social media correspondences on the social media webpage that reference the entity for the same period.

17. A method according to claim 12, wherein obtaining SEO data from the social media webpage of the entity comprises identifying the number of social media acknowledgements for the social media webpage of the entity.

18. A method according to claim 17, wherein the social media acknowledgements indicate that another webpage has a link to the social media webpage of the entity.

19. A method according to claim 17, wherein the social media acknowledgements are produced by users of a social media of the social media webpage.

20. A method according to claim 17, further comprising tracking the number of social media acknowledgements for the social media webpage of the entity for a period.

21. A method according to claim 20, further comprising comparing the number of social media acknowledgements for the social media webpage of the entity for the period to organic search results for the webpage of the entity for the same period.

22. A method according to claim 12, wherein the social media webpage is a social networking webpage.

23. A computer readable medium encoded with a computer program having computer-executable instructions for causing a computing system to perform operations for improving SEO performance of a social media webpage of an entity, the operations comprising:
obtaining SEO data from a webpage of the entity;
obtaining SEO data from the social media webpage of the entity; and
generating a report based on the SEO data from the webpage and SEO data from the social media webpage that indicates a level of the search engine optimization performance of the social media webpage of the entity.

24. A computer readable medium according to claim 23, wherein the computer readable medium comprises a memory device.

25. A computing system having the computer readable medium of claim 23.
